(19) United States
(12) Patent Application Publication
(10) Pub. No.: US 2021/0215053 A1
(43) Pub. Date: Jul. 15, 2021

(54) MOVABLE BLADE

(71) Applicant: SAFRAN AIRCRAFT ENGINES, PARIS (FR)

(72) Inventors: Josserand, Jacques, André BASSERY, MOISSY-CRAMAYEL (FR); Alexandre GIMEL, MOISSY-CRAMAYEL (FR); Ba-Phuc TANG, MOISSY-CRAMAYEL (FR); Vijeay PATEL, MOISSY-CRAMAYEL (FR); Stéphane KNITTEL, MOISSY-CRAMAYEL (FR)

(73) Assignee: SAFRAN AIRCRAFT ENGINES, PARIS (FR)

(21) Appl. No.: 17/273,566

(22) PCT Filed: Sep. 3, 2019
(86) PCT No.: PCT/FR2019/052027

§ 371 Date: Mar. 4, 2021

(30) Foreign Application Priority Data
Sep. 5, 2018 (FR) 1857965

(51) Int. Cl. F01D 5/28; F01D 5/14

(52) U.S. Cl. CPC F01D 5/288; F01D 5/141; F05D 2230/12; F05D 2230/312; F05D 2230/90; F05D 2300/6111; F05D 2250/75; F05D 2300/173; F05D 2300/174; F05D 2300/516; F05D 2240/307

(57) ABSTRACT

The invention relates to a movable blade made of aluminum and titanium alloy, for a turbojet engine turbine comprising a vane and at least one root at a distal end of the vane. The root has at least one azimuthal contact surface with another directly adjacent blade. A hard abrasion-resistant material, called wear-resistant material, is deposited onto the at least one azimuthal contact surface. A cavity is produced in said at least one azimuthal contact surface, the wear-resistant material being deposited in the cavity.

### FIELD OF THE INVENTION AND PRIOR ART

The present invention relates to the field of turbine blades.

In a turbojet, the turbine recovers a part of the energy originating from the combustion of gases for operating the fan, the compression and the accessories. Generally, two compressor modules and two turbine modules (high pressure and low pressure) are present.

Among the parts constituting the turbine, the moving wheels and the nozzle play an essential role.

In fact, after a combustion chamber, the gases will expand in the nozzle. This will accelerate the stream and will deflect it. Under the influence of this stream the moving wheels, which also have deflectors, rotate. This energy is used for the operation of the fan, the low-pressure compressor and the high-pressure compressor. The fixed stators, which straighten the deflected flow, are located between the moving wheels.

Each moving wheel consists of a plurality of blades. Each blade comprises essentially an airfoil having a suction side and a pressure side and two ends. At a proximal end of the airfoil (near the axis of rotation) the blade has a mounting root. At a distal end of the airfoil, the blade has a bead, particularly in the low-pressure part of the turbine.

Usually, the bead comprises at least two upper ribs (extending in an azimuthal direction) called rubbing strips, which allow ensuring a dynamic seal with the casing.

In addition, the bead generally comprises two azimuthal contact surfaces. Each azimuthal contact surface is in contact with a neighboring blade of the moving wheel. Each azimuthal contact surface has a deposit of hard material (most often cobalt-based), different from the material of the blade (most often nickel-based). The layer of hard material is called anti-wear material. The use of an anti-wear material is well known, it is possible to refer for example to document WO 2014/118456, which describes the application of an anti-wear material on a rubbing strip.

Once the blades are mounted in a ring in the moving wheel, the anti-wear material allow, by accomplishing damping by contact between blades, dissipating the vibratory energy of the natural mode of each blade. This function serves to prevent a vibratory fatigue fracture.

Current anti-wear materials are fastened by TIG (tungsten inert gas) welding via the application of an alloy of the KC28WN or KD28CS type depending on the engine configurations. In the particular case of blades made of titanium and aluminum alloy, it is not possible to accomplish a TIG weld. It is therefore necessary to apply anti-wear materials by another channel. In this specific case, the anti-wear materials are applied by thermal spraying. A plasma spray method is used to deposit a cobalt-based deposit which can have the composition cobalt-molybdenum-chromium-silicon (CoMoCrSi). This excessively thick deposit is not subsequently taken in machining. It is this deposit when ensures the operation of the anti-wear material.

Nevertheless, in both cases, the anti-wear material can have a tendency to come loose. It is then necessary to strip the bead, then again deposit an anti-wear material on it, which is long and expensive.

In this context, it is necessary to supply a blade to which the anti-wear material is durably fastened.

### GENERAL PRESENTATION OF THE INVENTION

According to a first aspect, the invention relates to a moving blade of titanium and aluminum alloy, for a turbojet turbine, comprising an airfoil and at least one bead at a distal end of the airfoil. The bead has at least one azimuthal contact surface with another directly adjacent blade. A hard abrasion-resistant material, called an anti-wear material, is deposited on at least one azimuthal contact surface. An indentation is made in said at least one azimuthal contact surface. The anti-wear material is deposited in the indentation.

In a particularly advantageous manner, the indentation allows fastening the anti-wear material recessed relative to the azimuthal contact surface. Thus, the interface (fastening) region between the anti-wear material and the bead is less exposed to friction and to shocks, which allows guaranteeing better anti-wear material strength. In addition, the fastening of the anti-wear material in the indentation allows having only the surface of the indentation to prepare for fastening, unlike known devices in which all the azimuthal contact surfaces are prepared (i.e. the preparation consists most often in a modification of the condition of the surface). In addition, the anti-wear material deposited in the indentation can have a greater thickness that the of the anti-wear material of known devices (the thickness of the anti-wear material being defined here by the depth of the indentation).

Said anti-wear material can be flush with the indentation.

This arrangement allows precisely maintaining the azimuthal dimensions of the bead without adding excess thickness to the azimuthal contact surface.

According to a particular arrangement, each azimuthal contact surface can have a plurality of successive facets defining a chevron-shaped profile. Each azimuthal contact surface can comprise one anti-wear material per facet.

The indentation can have a roughness comprised between 2 and 4 μm.

The indentation can have a depth comprised between 0.1 and 0.5 mm.

According to another aspect, the invention relates to a moving wheel for a turbojet turbine comprising a plurality of blades according to the invention. The blades are positioned circumferentially, the azimuthal contact surfaces of each blade being in contact with the azimuthal contact surfaces of two other adjacent blades. According to another aspect, the invention relates to a method of manufacturing a blade according to the invention, the method being characterized in that it comprises the steps of:

(a) manufacturing the blade comprising the bead,

(b) creating the indentation in the azimuthal contact surface of the bead,

(c) depositing an anti-wear material in the indentation.

According to a particular arrangement, step (b) can comprise a phase of machining the indentation by electrical discharge.

According to another particular arrangement, step (b) can comprise a phase of milling the indentation.

Step (b) can comprise a phase of sandblasting the indentation so that it has a roughness comprised between 2 and 4 μm.

Step (c) can comprise a phase of thermal spraying of the anti-wear material into the indentation.

### DESCRIPTION OF THE FIGURES

Other features and advantages of the invention will still be revealed by the description that follows, which is purely illustrative and not limiting, and must be read with reference to the appended figures in which:

FIG. 1 is an overview of a blade according to the invention,

FIG. 2 is a partial view of a first azimuthal contact surface of a blade according to the invention,

FIG. 3 is a partial view of a second azimuthal contact surface of a blade according to the invention,

FIG. 4 is a partial section view of an indentation.

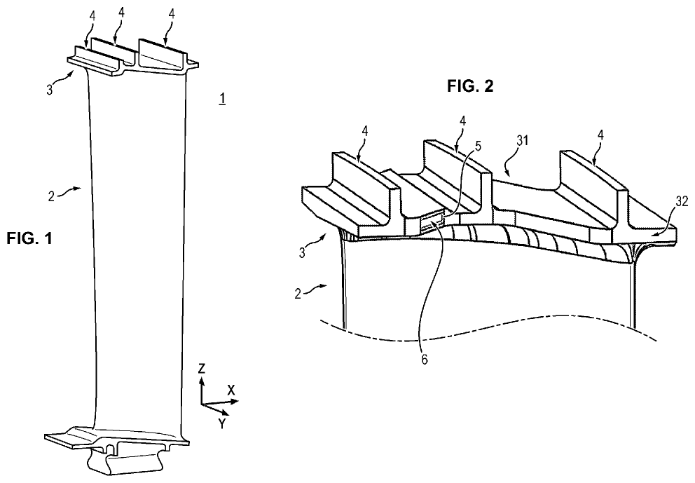

### DETALIED DESCRIPTION OF THE INVENTION

General Architecture

The invention relates to a moving blade 1 of titanium and aluminum alloy, for a turbojet turbine, comprising an airfoil 2 and a bead 3 at a distal end of the airfoil 2.

A reference of the blade 1 is defined comprising a longitudinal axis X (corresponding to a longitudinal axis of the turbojet, i.e. an axis of rotation of the rotor), a radial axis Z orthogonal to the longitudinal axis X, and an azimuthal axis Y (i.e. tangential, that is orthogonal to both the radial axis Z and to the longitudinal axis X).

According to the embodiment presented here, the bead 3 has two azimuthal contact surfaces 31 and 32 with another directly adjacent blade 1. Said “other blade” is in practice a neighboring blade of the same moving wheel, preferably identical to the blade 1 currently described.

The two azimuthal contact surfaces 31, 32 are opposite. The surface 31 of a blade 1 is in contact with the surface 32 of the other directly adjacent blade 1. By convention (and as shown in the drawings), it is possible to arbitrarily provide that the surface 31 is a suction side surface and the surface 32 is a pressure side surface for the blade 1.

In addition, the bead 3 has a series of ribs called rubbing strips 4. In operation, the rubbing strips 4 allow ensuring a dynamic seal between the blade 1 and a casing (not shown).

Usually, the blade 1 can be manufactured in an alloy of titanium and aluminum.

Indentation

According to the embodiment presented here, an indentation 5 is made in at least one, preferably each, azimuthal contact surface 31 and 32. It is specified that the number of indentations 5 in the azimuthal contact surfaces 31 and 32 is not limiting. If necessary, an azimuthal contact surface 31 or 32 can have, for example, two or three indentations 5. According to a particular arrangement, the indentations are made between the rubbing strips 4 in the azimuthal contact surfaces 31 or 32.

The method of making the indentation 5 will be detailed hereafter.

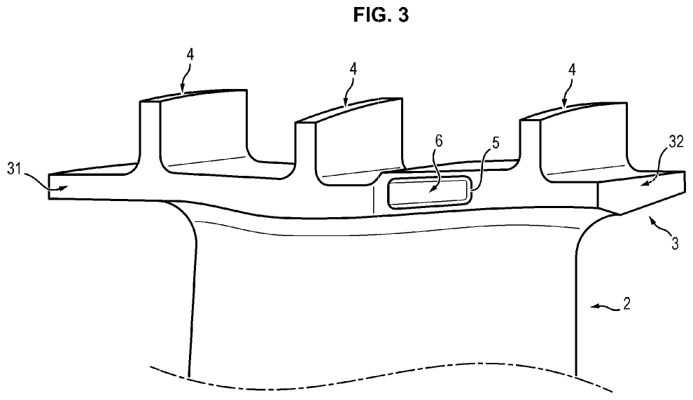

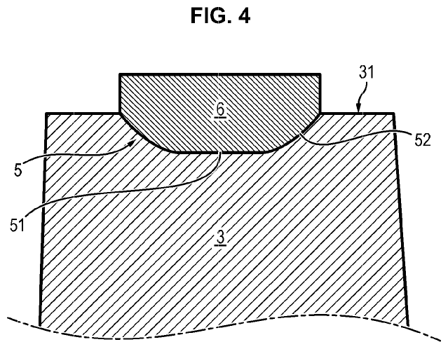

Referring to FIGS. 2 and 3, each indentation 5 can cover a substantially parallelepipedal area. In this case, each indentation 5 advantageously covers a substantially rectangular area.

As can be seen in FIG. 4, each indentation 5 can have a substantially flat bottom wall 51 and filets or chamfers 52 connecting the bottom wall 51 to the azimuthal contact surface 31 or 32.

Each indentation 5 can have a depth comprised between 0.1 and 0.5 millimeters. What is meant by depth is a dimension between the plane of the corresponding azimuthal contact surface 31 or 32 (in a direction orthogonal to this surface plane) and the plane of the bottom wall 51, or at least the deepest point of the indentation 5.

Preferably, each indentation 5 can have a depth substantially equal to 0.25 millimeters.

In addition, each indentation 5 can have a roughness comprised between 2 and 5 micrometers. The roughness defines the condition of the surface of each indentation 5. The roughness interval proposed here allows guaranteeing the proper fastening of an anti-wear material 6 in the indentation 5.

Anti-Wear Material

A hard abrasion resistant material, called an anti-wear material 6, is deposited in each indentation 5. By deposit is meant the application of matter in one manner or another into the indentation 5 so as to obtain an anti-wear material 6 fastened into the indentation 5.

A preferred method of depositing the anti-wear material 6 will be detailed subsequently, but advantageously, said material is applied in a liquid, solid or pasty state so that the anti-wear material 6 is created in situ in the indentation.

The anti-wear material 6 can be a cobalt-based alloy. According to a particular arrangement, the anti-wear material 6 can have the following composition: cobalt-molybdenum-chromium-silicon (CoMoCrSi).

Preferably, each anti-wear material 6 is flush with the indentation 5 in which it is positioned. In other words, the visible surface of the anti-wear material 6 extends slightly beyond the azimuthal contact surface 31 or 32. According to a preferred arrangement, the anti-wear material 6 is flush by less than 60 microns from the indentation 5 in which it is positioned. In other words, according to a preferred arrangement, the anti-wear material 6 extends by less than 60 microns beyond the azimuthal contact surface 31 or 32.

Manufacturing Method

The manufacturing method of the blade 1 preferably comprises the following steps of:
(a) manufacturing a blade 1 comprising a bead 3, the bead 3 being at this stage a “normal” bead, i.e. conforming to the prior art, i.e. without an indentation 5,
(b) creating at least one indentation 5 in the, or each azimuthal contact surface 31 or 32,
(c) depositing an anti-wear material 6 in the, or each indentation 5.

Step (a) of manufacturing the blade 1 can be carried out by casting, or forging, and/or machining.

The manufacture of the general shape of the blade 1 is accomplished according to known methods which will therefore not be developed.

In other words, rather than directly creating a blade 1 with a bead 3 provided with the indentation(s) 5, the indentation is made a posteriori by removing material. It will be noted, however, that the present invention is not limited to this manufacturing method and that it is completely possible to directly produce a blade 1 with a bead 3 directly provided with the indentation(s) 5 (for example by casting), even if that is more complex.

According to a particular arrangement, step (b) can comprise a phase of machining the indentation 5 by electrical discharge.

According to another particular arrangement, step (b) can comprise a phase of milling the indentation 5.

It is remarkable that machining by electrical discharge or by milling can be accomplished to form the indentation 5 from a “raw” bead 3 initially devoid of an indentation 5; or can be accomplished on a bead 3 already having an indentation 5, to improve its surface condition.

Regardless of the selected embodiment (in particular the machining mode if the indentation 5 is formed a posteriori in the bead 3) for obtaining the bead 3 provided with the indentation 5, the surface state of the indentation 5 can be taken up to modify its roughness.

Thus, preferentially, step (b) can comprise a phase of sandblasting the indentation 5 so that is has a roughness comprised between 2 and 4 μm.

Finally, an anti-wear material 6 is deposited (i.e. fastened) in each indentation 5. Preferably, step (c) of fastening anti-wear materials 6 can be accomplished by plasma spraying. Alternatively, step (c) could, for example, be accomplished by TIG welding.

Behavior Under Operating Conditions

Under operating conditions, several blades are fastened into a ring to form a moving wheel (not shown).

The azimuthal contact surfaces 31, 32, coincide, and the anti-wear materials 6 of each blade 1 are advantageously in contact with the anti-wear materials 6 of a neighboring blade 1.

The anti-wear materials 6 allow absorbing the vibrations of the blades 1 as well as inter-blade 1 shocks. The hardness of the anti-wear material 6 allows them to absorb shocks and friction while preserving the rest of the bead 3 which is of a softer material.

In a particularly advantageous manner, the fastening of the anti-wear materials 6 in the indentations 5 allows the anti-wear material to be flush relative to the indentation 5 and to the azimuthal contact surfaces 31 and 32, so that the anti-wear material 6 has only very little excess thickness relative to the azimuthal contact surface 31 or 32, which limits the clearance of the blades 1.

In addition, the deposition of anti-wear materials 6 in the indentations 5 allows the interface, attachment zone of the anti-wear material 6 to be recessed relative to the azimuthal contact surface 31 or 32, and therefore to be less exposed to shocks. In addition, the positioning of the anti-wear material 6 in the indentation 5 allows reinforcing the retention of the anti-wear material 6. In fact, it is held, on the one hand, by the entanglement of an interface zone of the anti-wear material 6 with the surface of the indentation 5, as a result of partial fusion of the anti-wear material 6 during its deposition. On the other hand, the anti-wear material is also in an embedding connection in the indentation 5, where it is held by the edges of the indentation 5. Thus, the anti-wear material 6 is protected from a possible shear pullout.

In addition, the anti-wear material 6 fastened in the indentation 5 can, while being slightly flush, have a greater thickness than that of the anti-wear materials 6 of known devices (the thickness of the anti-wear material 6 being defined here from the bottom of the indentation 5), and therefore be more robust and more resistant to shocks.

Thus, the invention proposes a blade 1 in which the anti-wear material 6 is durably fastened.

1.-11. (canceled)

12. A moving blade of titanium and aluminum alloy, for a turbojet turbine, comprising an airfoil and at least one bead at a distal end of the airfoil, the bead having at least one azimuthal contact surface with another directly adjacent blade, a hard abrasion-resistant material, called an anti-wear material, being deposited on at least one azimuthal contact surface, the blade being characterized in that an indentation is made in said at least one azimuthal contact surface, the anti-wear material being deposited in the indentation, and each azimuthal contact surface has a plurality of successive facets defining a chevron-shaped profile, each azimuthal contact surface comprising one anti-wear material per facet.

13. The blade according to claim 12, characterized in that said anti-wear material is flush with the indentation.

14. The blade according to claim 12, wherein the indentation has a roughness comprised between 2 and 4 μm.

15. The blade according to claim 12, wherein the indentation has a depth comprised between 0.1 and 0.5 mm.

16. A moving wheel for a turbojet turbine comprising a plurality of blades according to claim 12 positioned circumferentially, wherein the azimuthal contact surfaces of each blade being in contact with the azimuthal contact surfaces of the two other adjacent blades.

17. A method of manufacturing a blade according claim 12, the method being characterized in that it comprises the steps of:
(a) manufacturing the blade comprising the bead,
(b) creating the indentation in the azimuthal contact surface of the bead,
(c) deposition of an anti-wear material in the indentation.

18. The method according to claim 17 wherein step (b) comprises a phase of machining the indentation by electrical discharge.

19. The method according to claim 17 wherein step (b) comprises a phase of milling the indentation.

20. The method according to claim 17, wherein step (b) comprises a phase of sandblasting the indentation so that it has a roughness comprised between 2 and 4 μm.

21. The method according to claim 17, wherein step (c) comprises a phase of plasma spraying of the anti-wear material into the indentation.
